(19) United States
(12) Patent Application Publication
(10) Pub. No.: US 2021/0330120 A1
(43) Pub. Date: Oct. 28, 2021

(54) FOOD COOKING SYSTEM

(71) Applicant: Duke Manufacturing Co., St. Louis, MO (US)

(72) Inventors: Daryl R. Monroe, Granite City, IL (US); John J. Hake, Edwardsville, IL (US); Douglas M. Lewis, St. Charles, MO (US)

(21) Appl. No.: 17/243,189

(22) Filed: Apr. 28, 2021

Related U.S. Application Data
(60) Provisional application No. 63/016,581, filed on Apr. 28, 2020.

(51) Int. Cl. A47J 37/06; A47J 37/04

(52) U.S. Cl. CPC A47J 37/0664; A47J 37/044

(57) ABSTRACT

A food dispenser, components thereof, and associated methods. The food dispenser dispenses food to a food cooking device. The food dispenser includes a loader having a bed and at least one pusher for pushing food along the bed toward the food cooking device. A hopper includes a plurality of food racks holding a plurality of food items in the hopper to be transferred to the bed of the loader. The food racks hold the plurality of food items in multiple arrays, one array in front of the other, and each array includes a plurality of columns. A dispensing driver dispenses food items from the hopper to the bed of the loader.

### CROSS-REFERENCE TO RELATED APPLICATION

This application claims priority to U.S. Provisional Application No. 63/016,581, filed Apr. 28, 2020, the entirety of which is hereby incorporated by reference.

### FIELD

The present disclosure generally relates to a food handling apparatus, and more particularly to a food handling apparatus for staging food to be cooked, feeding the food to a food cooking device, and receiving cooked food from the food cooking device.

### BACKGROUND

Restaurants and other types of food preparation establishments use a variety of food cooking devices to cook food. In such establishments, food may be cooked in large quantities to meet production goals and/or demands of customers. Example food preparation devices include ovens, fryers, grills, etc. Manually loading food into or onto such food cooking devices can be labor intensive.

### SUMMARY

In one aspect, a food dispenser for dispensing food to a food cooking device comprises a loader. The loader comprises a bed and at least one pusher for pushing food along the bed toward the food cooking device. A hopper includes a plurality of food racks configured to hold a plurality of food items in the hopper for being transferred to the bed of the loader. The food racks are configured to hold the plurality of food items in multiple arrays, one array in front of the other. Each array includes a plurality of columns. A dispensing driver is configured to dispense food items from the hopper to the bed of the loader.

In another aspect, a food collector for receiving different types of food items from an outlet of a cooking device comprises a rack. The rack includes a plurality of food container supports. Each food container support is configured to hold a food container for collecting food therein. The plurality of food container supports being arranged in a column, one food support above another food support. A food container drive is operatively connected to the food container supports to move the column of food container supports upward and downward with respect to the outlet of the cooking device to position one of the food container supports for receiving food from the outlet of the cooking device into a food container supported by said one of the food container supports.

Other objects and features of the present disclosure will be in part apparent and in part pointed out herein.

### BRIEF DESCRIPTION OF THE DRAWINGS

FIG. 1 is a perspective of a food cooking system of the present disclosure;

FIG. 2 is a partially exploded perspective of a food dispenser of the system of FIG. 1;

FIG. 3 is a section of the food dispenser;

FIG. 4 is a view similar to FIG. 3 but showing a carriage and racks of the food dispenser moved rearward;

FIG. 5 shows perspectives of two food item cartridges for the food dispenser;

FIG. 6 shows perspectives of two food item cartridges for the food dispenser;

FIG. 7 is a perspective of the food dispenser dispensing food items to a bed of the food dispenser;

FIG. 8 is a perspective of the food dispenser dispensing additional food items to the bed;

FIG. 9 is a perspective of the food dispenser showing a loader pushing the food items into a cooking device;

FIG. 10 is a view similar to FIG. 9 but showing the food items pushed farther into the cooking device;

FIG. 11 is a view similar to FIG. 10 but showing the food fully pushed into the cooking device;

FIG. 12 is an elevation of the system showing a food collector for receiving food from the cooking device;

FIG. 13 is another elevation of the system showing the food collector;

FIG. 14 is a schematic of a control system of the food cooking system;

FIG. 15 is a perspective of another embodiment of a food dispenser;

FIG. 16 is a section of the food dispenser of FIG. 15; and

FIG. 17 shows perspectives of another embodiment of a food dispenser illustrating a sequence of dispensing food items therefrom.

Corresponding reference characters indicate corresponding parts throughout the drawings.

### DETAILED DESCRIPTION

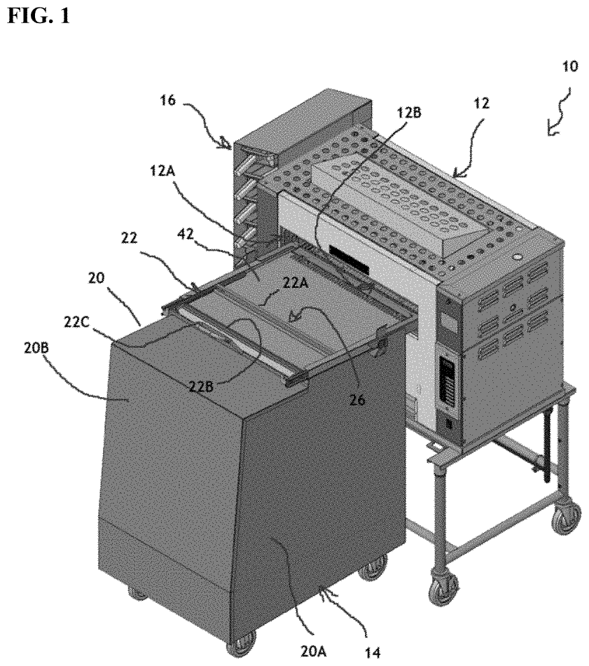

Referring to FIG. 1, a food cooking system of the present disclosure is designated generally by 10. The food cooking system 10 includes a food cooking device 12, a food dispenser 14 for dispensing food to the food cooking device, and a food collector 16 for collecting cooked food from the food cooking device.

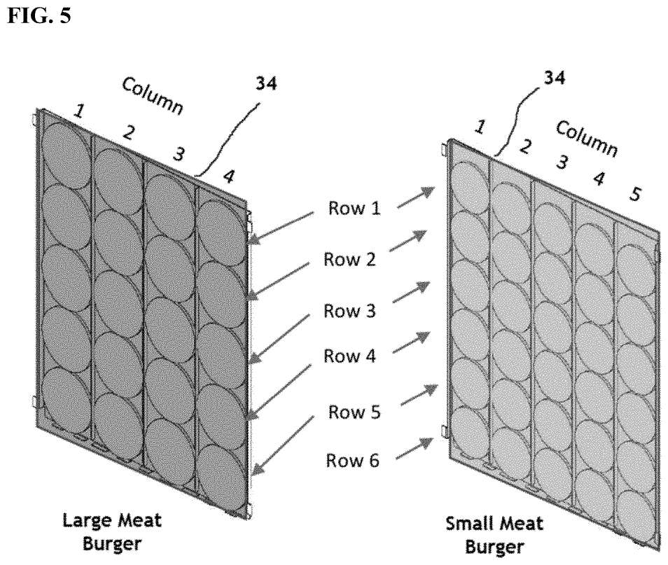

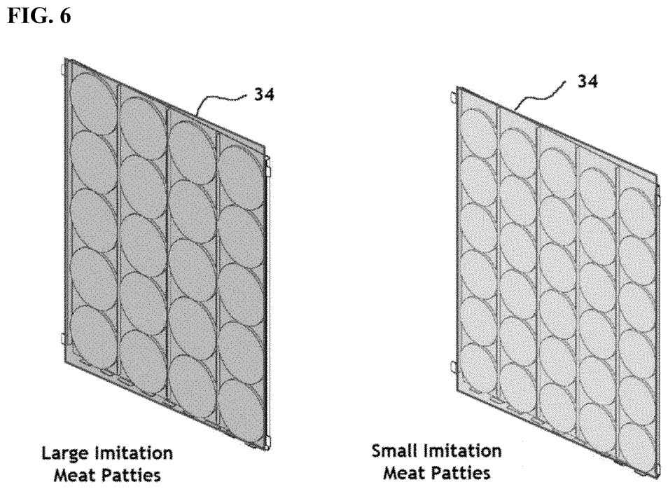

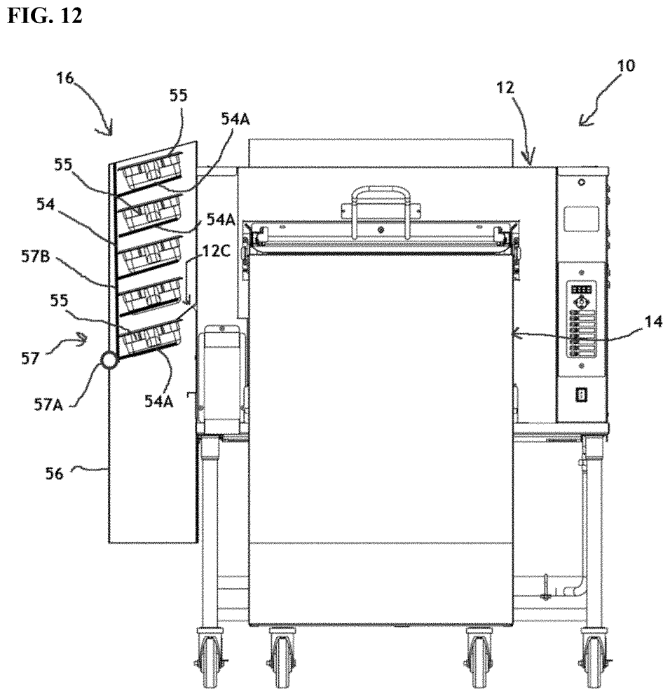

In the illustrated embodiment, the food cooking device 12 comprises an oven, and in particular a broiler. The food items can be a plurality of patties, such as large and small meat burger patties, and large and small imitation meat burger patties (FIGS. 5 and 6). The cooking device 12 comprises a food inlet 12A for receiving food to be cooked, a cooking chamber 12B for cooking the food, and an outlet 12C (FIG. 12) for discharging cooked food. For example and without limitation, the cooking device can be of the type disclosed in U.S. Pat. No. 7,921,767, the entirety of which is hereby incorporated by reference. Food loaded into the cooking chamber 12B rests on a conveyor, where the food is cooked. When the food is finished cooking, the food is moved by the conveyor to the outlet 12C. It will be appreciated that other types of food cooking devices could be used, such as other types of ovens or fryers, grills, etc.

The food dispenser 14 is configured to feed food to the cooking device 12 for cooking the food. The dispenser 14 includes a cabinet 20 (broadly, “hopper”) for holding a plurality of food items. The dispenser 14 also includes a loader 22 for loading food from the cabinet 20 into the cooking device 12. The food items are staged in the cabinet 20 until transferred through a slot 26 to the loader 22 for loading into the cooking device 12. The cabinet 20 includes a front side facing the cooking device 12, a rear side opposite the front side, and opposite left and right sides. Wheels are provided at the bottom of the cabinet 20 for rolling the cabinet on the floor. In this embodiment, the loader 22 is located at a top of the cabinet 20.

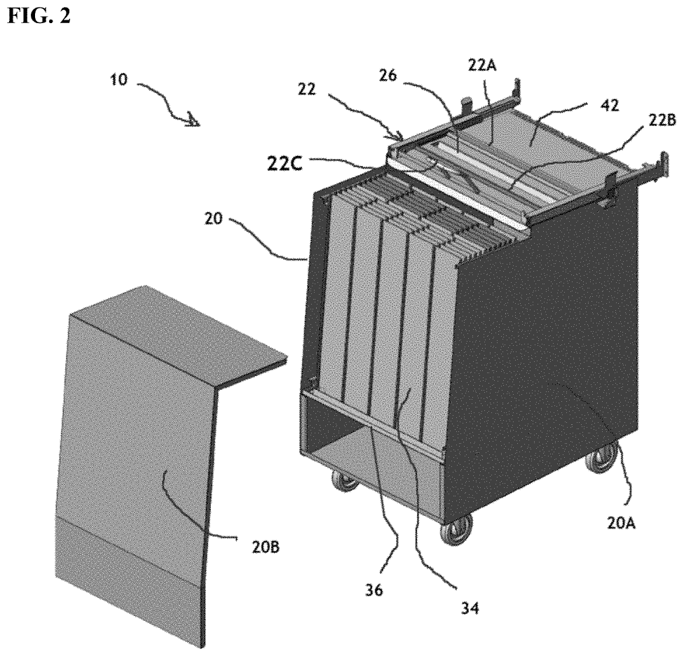

The cabinet 20 includes a housing 20A defining an interior in which the food items are held. For example, the cabinet 20 could be a freezer including an appropriate refrigeration system 30 (e.g., condenser, compressor, evaporator, expansion valve, etc.) and insulated housing 20A for maintaining the food items in a frozen or refrigerated state. As shown in FIG. 2, the cabinet 20 includes a door 20B that permits access to the interior for loading food into the cabinet (e.g., loading cartridges 34 holding food into the cabinet). In the illustrated embodiment, the door 20B closes rear and upper openings in the housing. In other embodiments, the door may be provided on the left and/or right sides of the cabinet instead of the rear of the cabinet.

Food items are stored in the cabinet 20 in a plurality of cartridges 34, one cartridge in front of the other. Each cartridge 34 holds a plurality of food items arranged in an array including a plurality of columns, which may be referred to as lanes. One or more cartridges 34 can be referred to as a rack. Referring to FIGS. 5-6, the cartridges 34 can be configured to carry different types and/or sizes of food items, such as large and small meat burger patties, and large and small imitation meat burger patties, although other types of food items can be carried by the cartridges without departing from the scope of the present disclosure. A variety of these cartridges 34 can be held in the cabinet 20 so different types of food items can be fed to the cooking device 12. The different types of patties can be dispensed from the cabinet 20 for cooking in the same or different batches. Some cartridges 34 may be “split” cartridges configured to receive a first type of food item in one or more columns on a left side of the cartridge and a different type of food item in one or more columns on a right side.

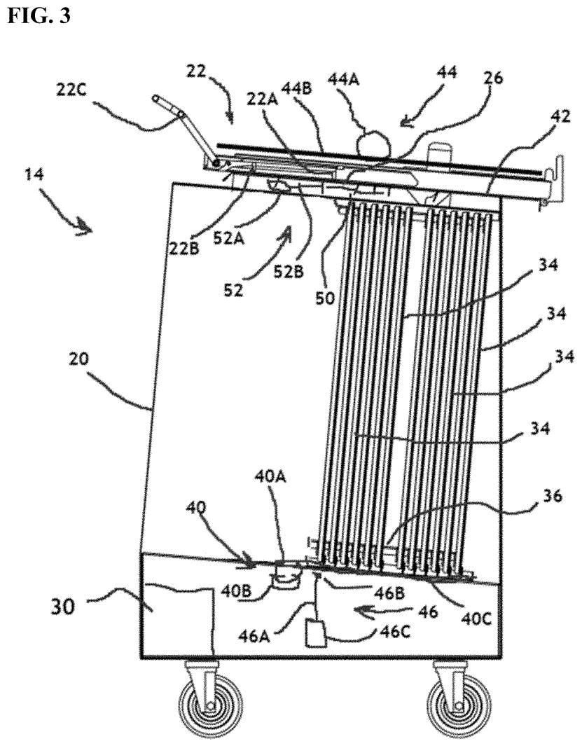

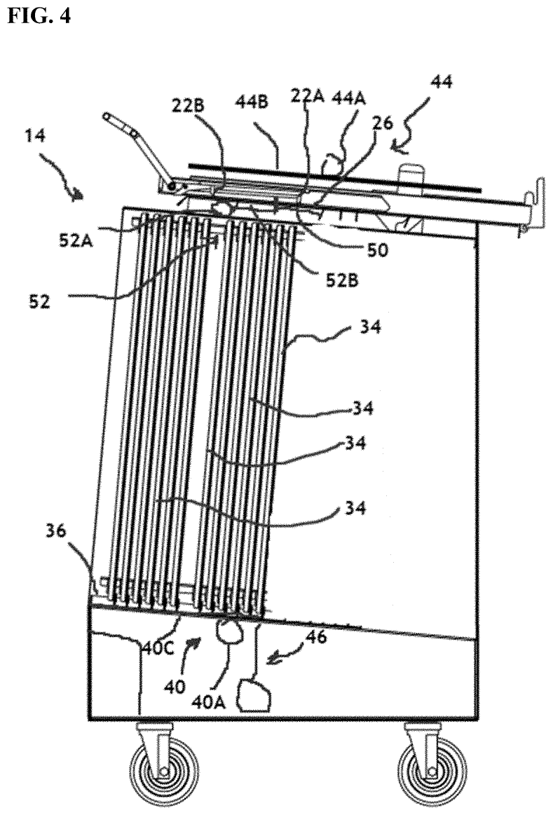

The cartridges 34 are supported in the housing on a carriage 36. The carriage 36 is movable in the cabinet 20 forward and rearward to index the cartridges 34 for transferring food items stored thereon to the loader 22. In the illustrated embodiment, a carriage driver 40 includes a pinion gear 40A driven by a motor 40B, and a rack gear 40C on the carriage in mesh with the pinion gear. Rotation of the pinion gear 40A by the motor 40B drives the carriage 36 forward or rearward. The carriage 36 is shown in a fully forward position in FIG. 3 and in a fully rearward position in FIG. 4. It will be appreciated that the carriage 36 is movable between these positions to a plurality of intermediate positions to locate each of the cartridges 34 for dispensing food items threrefrom through the slot 26. Other types of carriage drivers (e.g., chain drive, scissors mechanism, etc.) can be used without departing form the scope of the present disclosure. The carriage 36 or may be extendable out of the interior of the cabinet 20 (e.g., through a door) for loading/unloading cartridges.

The loader 22 is arranged to push food from a bed 42 on a top of the cabinet 20 into the cooking device 12. In particular, the loader 22 is configured to push two rows of food items into the oven. The loader 22 includes a frame comprising a first pusher 22A for pushing the first row of food items and a second pusher 22B for pushing the second row of food items. A loader driver 44 (FIG. 3) is configured to conjointly move the first and second pushers 22A, 22B forward and rearward. For example, the loader driver 44 can comprise a motor-driven pinion gear 44A in mesh with a rack 44B connected to the loader 22 for moving the first and second pushers 22A, 22B. Rotation of the pinion gear 44A in a first direction causes the pushers to move forward toward the cooking device 12, and rotation of the pinion gear in the opposite direction causes the pushers to move rearward. It will be appreciated that other types of loader drivers (e.g., screw drive, chain drive, belt drive, scissors mechanism, etc.) can be used without departing from the scope of the present disclosure.

Food is transferred from the cartridges 34 in the cabinet to the bed 42 through the slot 26 (broadly, “opening”) in the top of the cabinet 20. When food is to be transferred from a particular cartridge 34 to the bed 42, the cartridge is moved by the carriage driver 40 forward or rearward so a top of the cartridge 34 is in register with the slot. The carriage driver 40 may include an encoder for properly locating the carriage with respect to the slot 26 for dispensing food from a desired cartridge 34. When the desired cartridge 34 is in register with the slot 26, food from the cartridge is driven upward such that a food item from the cartridge is moved out of the slot onto the bed 42. For example, the food item can be driven upward by a food driver 46 (e.g., elevator). The food driver 46 can be configured to drive food in a single column of the cartridge 34 upward and/or can be configured to drive food in multiple columns of the cartridge upward (e.g., all the columns of the cartridge simultaneously). For example and without limitation, the food driver 46 can include a screw drive 46A and/or a chain drive, a belt drive, a scissors mechanism, etc. configured to move one or more food engagement heads 46B to push the food items in a column upward such that a food item at a top of the column exits the cartridge 34, passes through the slot 26, and falls onto the bed 42. The food driver 46 can include a motor 46C for moving the mechanism 46A and food engagement heads 46B. The food driver 46 can comprise multiple components (e.g., drive components and food pushing heads), some of which may be mounted on the cabinet 20 and/or some of which may be carried by the cartridges 34. An encoder can be used to operate the food driver 46 to dispense food items one food item at a time, or one row of food items at a time, onto the bed.

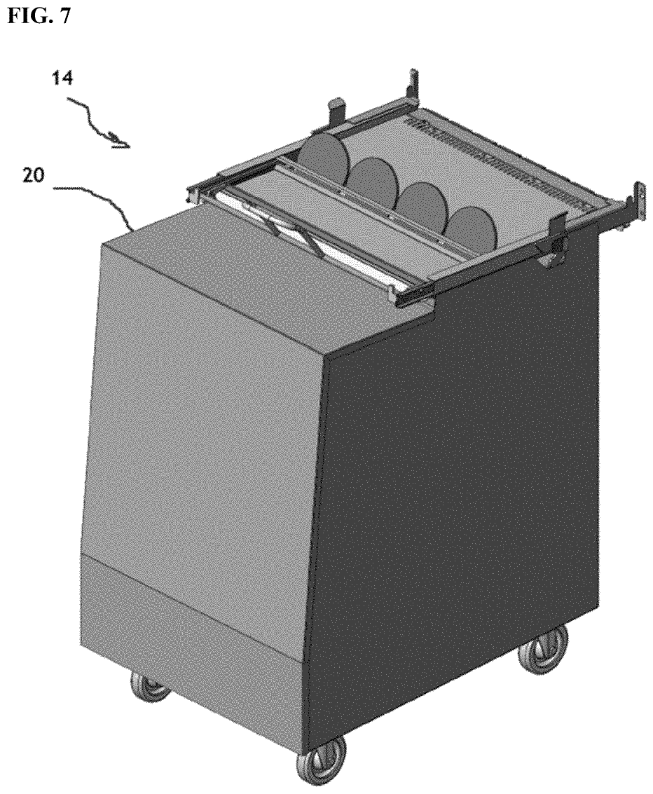

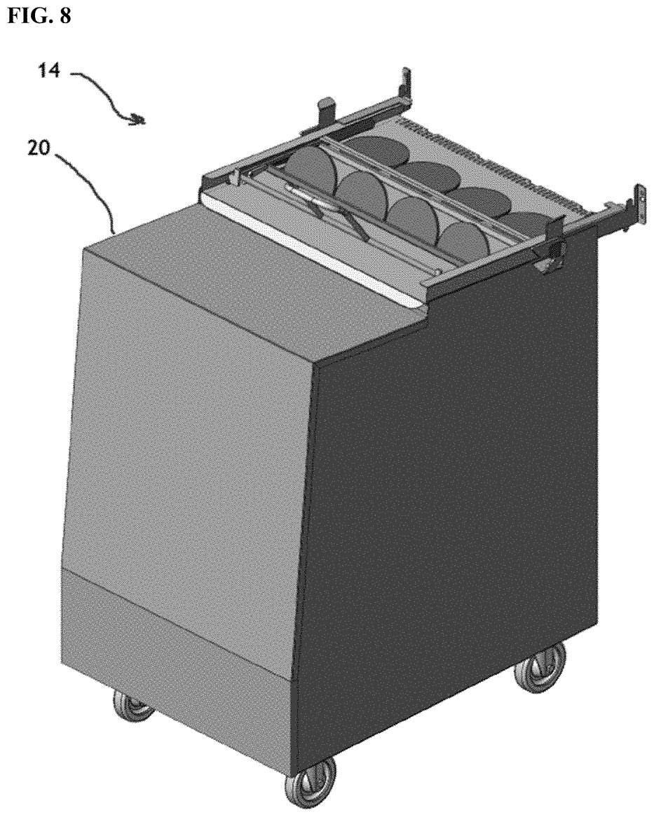

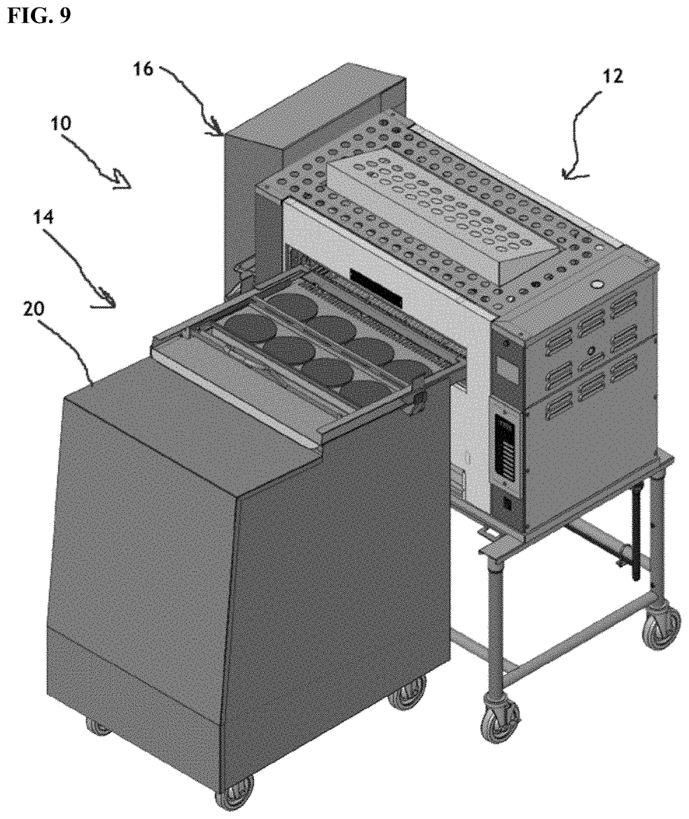

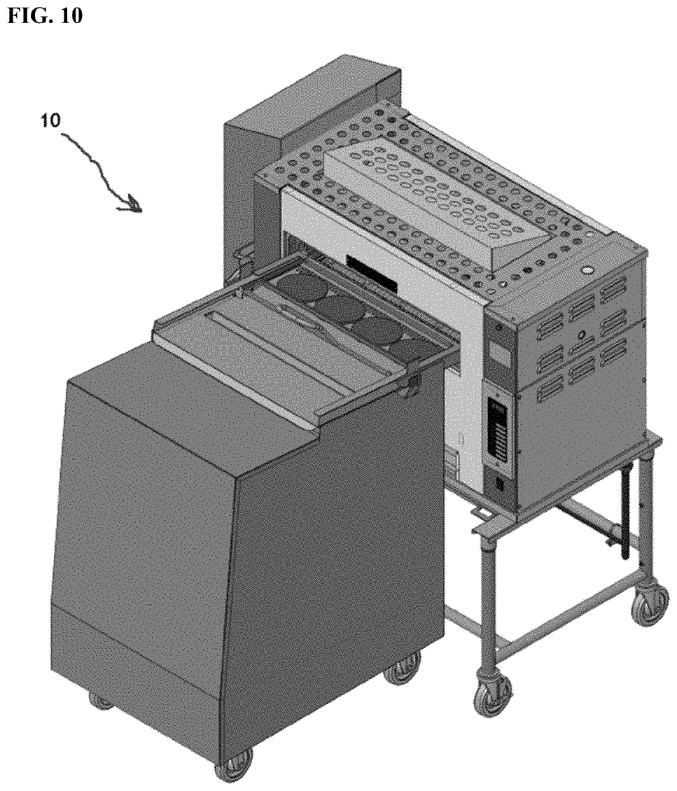

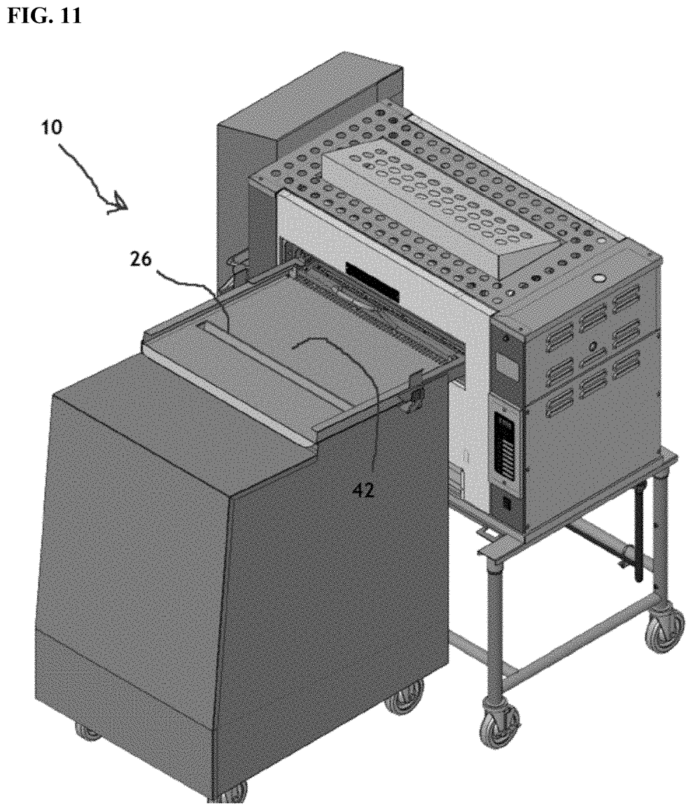

A cycle of dispensing food from the cabinet 20 to the oven 12 is shown in sequence in FIGS. 7-11. Referring to FIG. 7, the loader 22 is shown in a retracted position ready to receive food items to load into the oven 12. In FIG. 7, the food driver 22 is pushing a row of food items from a cartridge 34 through the slot 26 into the first row of the loader (in front of the first pusher 22A). In FIG. 8, the first row of food items has settled on the bed 42 and has been pushed forward by the loader 22 to position the second pusher 22B with respect to the slot 26 for receiving a second group of patties in front of the second pusher. The second group of patties is shown partially ejected from the slot 26 in FIG. 8. The second group of patties can be delivered from the same cartridge 34 or a different cartridge as the first set of patties. As shown in FIG. 9, two rows of patties are received by the loader 22 and are being loaded into the oven 12. As shown in sequence in FIGS. 9-11, the loader driver 44 moves the loader 22 to an extended position to feed the two rows of patties into the oven 12. After pushing the patties into the oven 12, the loader 22 returns to the retracted position for receiving additional patties. The loader driver 44 can include an encoder for moving the loader 22 to preset positions relative to the slot 26 and the cooking device 12. The loader 22 may push the two rows of patties into the oven 12 as generally the same time (e.g., one right after the other) or may push the first or front row of patties into the oven and then wait a set amount of time, such as 1-5 minutes, before pushing the second or rear row of patties into the oven.

Although the example illustrated in FIGS. 7-11 shows eight of the same type and size of burger patties in the loader 22, it will be appreciated that different types and sizes of burger patties (or other food items) can be dispensed to the loader by the food driver 46, such as from multiple different cartridges 34. For example, the food driver 46 may drive a patty of a first type into the left most position of the front row of the loader, and then drive three patties of a second type from a different cartridge into the three other positions in the row (e.g., after the carriage driver moves the carriage to position the different cartridge in register with the slot 26).

As shown in FIG. 3, the cabinet 20 could include a door 50 configured to selectively open and close the slot 26 in the top of the cabinet 20 to permit food items to pass through the slot and to retain cold air in the cabinet when not transferring food items through the slot. The door 50 could comprise a sliding or pivoting door and could be moved between opened and closed positions by a door driver 52 including a door driving motor 52A and a rack and pinion, scissors, belt, chain, screw, and/or other drive mechanism 52B.

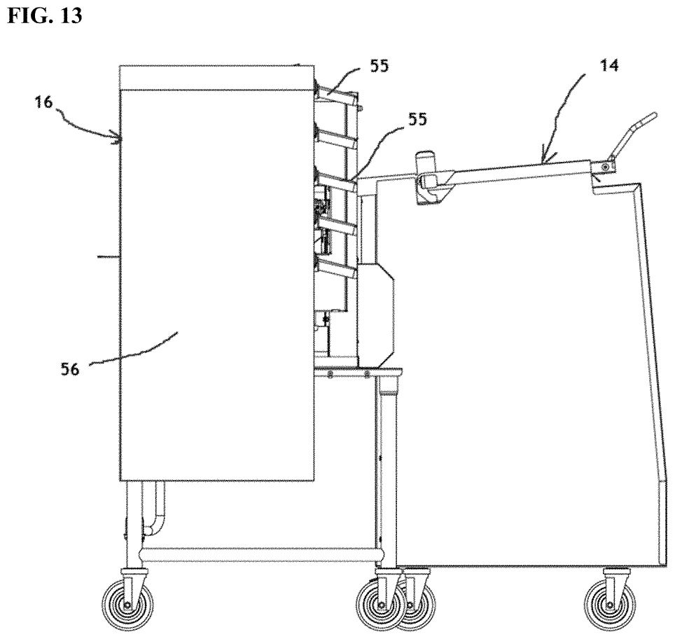

Referring to FIGS. 12 and 13, the food collector 16 includes a frame 54 comprising a plurality of food container supports 54A for holding respective food containers 55 (e.g., pans or trays). Each container 55 may be designated for holding a certain type of food item (e.g., small meat burger patties, large imitation meat burger patties, etc.). The food collector 16 includes an optional housing 56 to house the food containers 55 on the supports 54A to maintain the cooked food in a warm state until it is removed from the food collector 16. The housing 56 may be arranged to receive heat from the food cooking device 12 to maintain the food warm in the holding containers 55. The food collector 16 includes a collector driver 57 configured to move the food container supports 54A to locate a selected one of the food containers 55 to receive food items discharged from the cooking device 12. In the illustrated embodiment, the food container supports 54A are arranged in a column, one food container support above another, to hold the food containers 55 in stacked arrangement, and the food container supports are movable by the collector driver 57 upward and downward to position the appropriate food container 55 for receiving the cooked food from the cooking device 12 (e.g., from a chute or slide at the cooking device outlet). For example, the collector driver 57 could include a motor-driven pinion gear 57A in mesh with a rack gear 57B operatively connected to the frame 54 for moving the container supports 54A upward and downward. Other types of collector drivers, including scissors, screw, belt, chain, etc. drives, can be used without departing form the scope of the present disclosure.

The conveyor in the cooking device 12 may comprise first and second side-by-side conveyors defining adjacent lanes. The two conveyors could be operated independently to discharge food items from the conveyors into containers 55. If the batch of food in the cooking device 12 comprises different sizes and/or types of food products, (e.g., some small meat burger, some large meat burger, some small imitation meat burger, and/or some large imitation meat burger), the conveyors may operate in cooperation with movement of the food container supports 54A of the food collector 16 to discharge food items to the specific food container 55 intended to hold such food products. For example, the left conveyor of the cooking device 12 may dispense a first burger patty of a first type (e.g., small meat burger patty) into a first container 55. Then the food collector 16 may move a second container 55 into registration with the cooking device outlet 12C, after which the right conveyor of the cooking device 12 dispenses second and third burger patties (e.g., large imitation meat burger patties) of a second type into the second container 55.

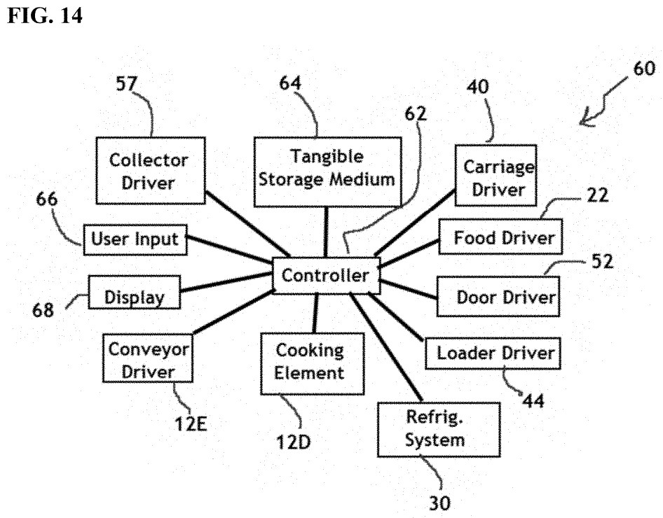

Referring to FIG. 14, an example control system 60 is provided for controlling operation of the food dispenser 14, food cooking device 12, and/or food collector 16. The control system 60 includes a controller 62 (e.g., dispenser controller, cooking device controller, and/or food collector controller) such as one or more microprocessors, a non-transitory tangible storage medium 64 (e.g., including firmware and software) storing instructions executable by the controller, and a user interface comprising a user input 66 (e.g., one or more actuators, such as buttons, as on a touch screen control) and a display 68 (e.g., display of touch screen). The controller 62 is responsive to user input to store, modify, and execute instructions stored on the tangible storage medium. The instructions stored on the tangible storage medium 64 may embody one or more of the functional aspects of the food dispenser 14, the food cooking device 12, and/or the food collector 16 described herein such that executing with the controller 62 the instructions results in the one or more functional aspects being performed by the corresponding components (e.g., food dispenser, food cooking device, food collector and/or associated components). The tangible storage medium 64 can store, and the user can view, modify, and edit, via the user interface, information such as the number and location of racks in the cabinet 20 (in particular positions on the carriage), the type and number of food patties in each cartridge 34, etc. The controller 62 is in communication with the tangible storage medium 64, user interface 66, 68, and other control system components via interconnections electronics, such as wired or wireless connections. The controller 62 is in operative communication with the carriage driver 40, food driver 22, door driver 52, and loader driver 44 for controlling and coordinating operation thereof In embodiments where the controller 62 also controls the cooking device 12 and/or the food collector 16, the controller is operatively connected to components thereof (e.g., cooking element 12D, cooking device conveyor driver 12E, food collector driver 57, etc.) for coordinating operation of the entire food cooking system 10.

In a method of using the food cooking system 10, a user installs food items to be held in the cabinet 20. The food items can be installed in a default manner matching default settings the controller 62 expects with respect to number of cartridges 34, location of cartridges on the carriage 36, number and type of food item in each cartridge, etc. Alternatively, the user can load a custom arrangement of food items (differing from default or what is called for by the controller 62) and notify the controller 62 of the food inventory via the user interface (e.g., enter a custom inventory into the tangible storage medium 64 indicative of the food inventory actually installed). The user can manipulate the user input 66 to instruct the dispenser 14 to dispense food including a certain number and type of food items from inventory to the cooking device 12. Alternatively, instructions could come from a product management system, which monitors predicted future demand (based on historical orders, real-time orders, and trends), to instruct the cooking system 10 to cook certain types and numbers of food items to meet the predicted demand. In some cases, real-time orders may exceed predicted demands, and employees can instruct the system 10 to cook food items in excess of the predicted demand. Responsive to the instructions, the controller 62 operates the carriage driver 40, door driver 52, food driver 22, and the loader driver 44 to dispense food from one or more cartridges 34 to the bed 42 and to load the food items from the bed into the cooking device 12. The cooking device 12 cooks the food items according to a cooking recipe stored on the tangible storage medium 64 and discharges the food items from the cooking device to the cooked food collector 16.

In an aspect of the present disclosure, the food dispenser 14 can be used to load food items into the food cooking device 12 at different times and to be cooked in the food cooking device together. For example, large burger patties may be loaded into the cooking device 12 and cooked before small burger patties are loaded into the cooking device and cooked together with the large burger patties for a remaining period of a cook duration. The large burger patties could be dispensed to the loader bed 42 for being pushed by the front food pusher 22A into the cooking device 12. When the loader 22 is retracted to the bed 42, the row of small burger patties is dispensed to be pushed by the rear pusher 22B. After the large burger patties have cooked for some time, the small burger patties are pushed into the cooking device 12 by the loader to cook with the large burger patties.

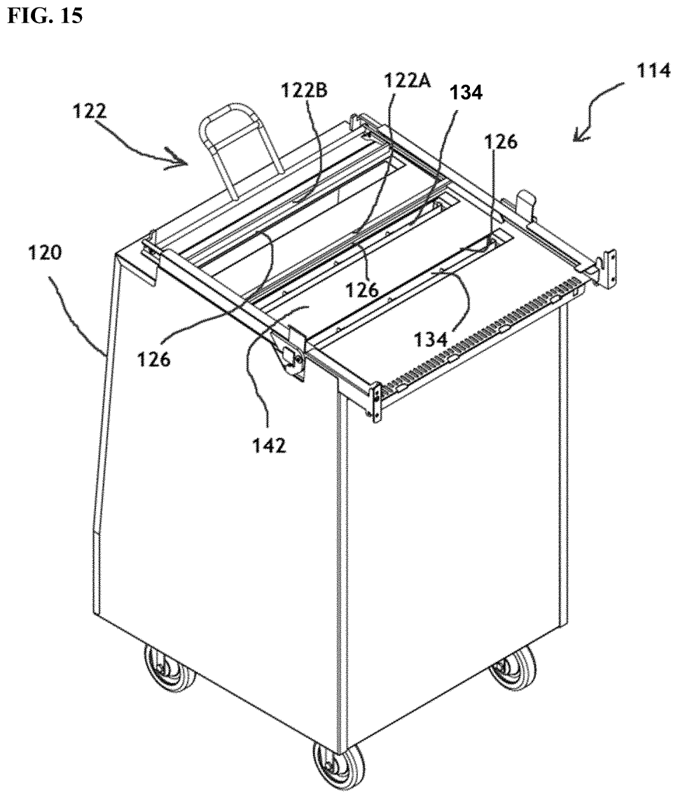

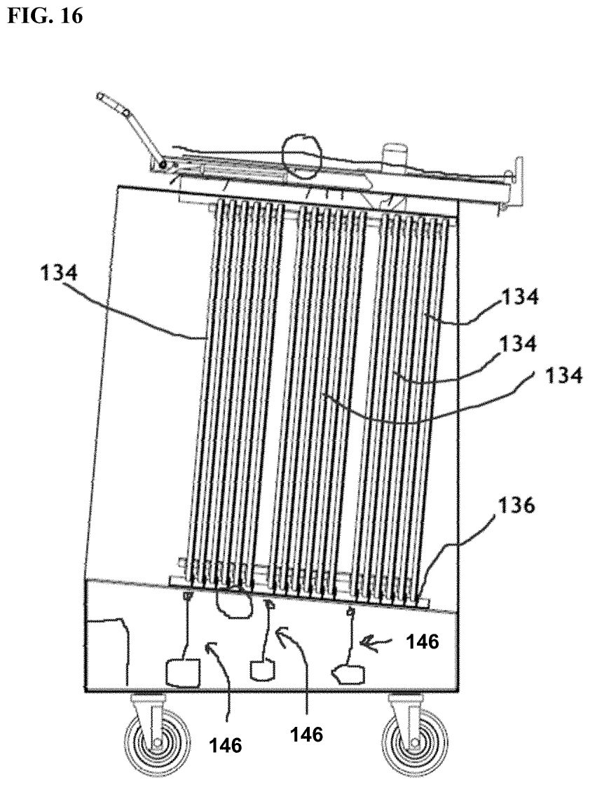

Referring to FIGS. 15 and 16, an alternative embodiment of the food dispenser is indicated generally by 114. The food dispenser 114 has the same construction as the dispenser 14 except as described hereafter, and like numbers are indicated by like reference numbers, plus 100. For example, the food dispenser 114 includes a cabinet 120 housing a plurality of cartridges 134 (broadly, one or more cartridges being a “rack”) movable by a carriage 136. In this embodiment, multiple slots 126 (broadly, “openings”) are provided to dispense food items from the cartridges 134 in the cabinet 120 to the loader bed 142. The multiple slots 126 permit greater flexibility in moving the carriage 136 to index cartridges 134 with different ones of the slots 126 for dispensing food items to the front and rear pushers 122A, 122B of the loader 122. A respective food driver 146 may be associated with each one of the slots 126, and multiple food drivers may operate simultaneously to dispense food items to the bed 142 from different cartridges 134 at the same time. It will be appreciated that other numbers of slots and food drivers can be used without departing from the scope of the present disclosure.

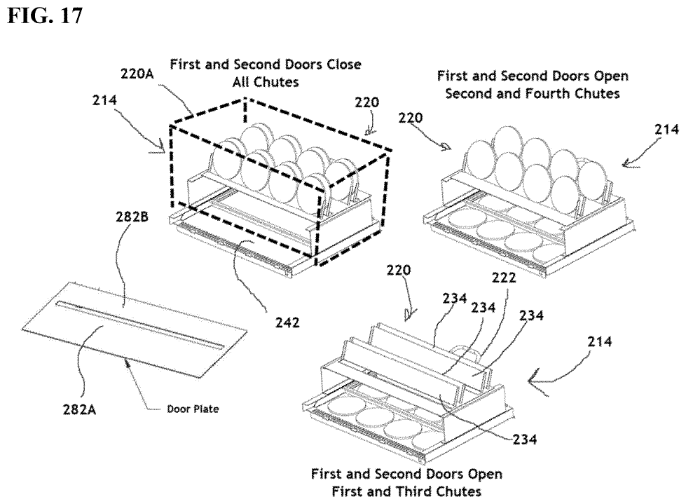

Referring to FIG. 17, another alternative embodiment of the food dispenser is indicated generally by 214. In this embodiment, the food dispenser 214 is configured to dispense food items by gravity to the loader bed 242. The hopper 220 can optionally include a housing 220A (e.g., insulated and/or refrigerated) at least partially covering or surrounding the racks 234 (e.g., chutes). The racks 234 are each configured to hold an array of food items, one array in front of another array. Each array includes multiple side-by-side columns of food items. In the illustrated embodiment, each column is only one food item tall, but it will be appreciated that the racks could be taller for holding additional food items in the columns. Moreover, it will be appreciated that other numbers of racks (e.g., additional racks) may be used. The hopper 220 includes first and second sliding doors 282A, 282B (e.g., parts of a common door plate) conjointly movable forward and rearward. Although the doors 282A, 282B are shown separated from the racks 234, it will be understood that in use the doors are assembled with the racks 234 to underlie the racks and are slidable under the racks to selectively permit food from the racks to fall downward. In operation, the racks 234 would be loaded with food items such as burger patties. To dispense food items from the hopper 220 to the loader 222, the first and second slide doors 282A, 282B are moved forward (toward the oven) to open slots below two racks 234 of food items. Some of the food items fall onto the bed 242 in front of the first pusher of the loader 222, and other food items fall onto the bed in front of the second pusher. The loader 222 pushes the first and second rows of patties into the cooking device as in the embodiments described above. When it is time to dispense additional patties to the loader 222, the front and rear doors 282A, 282B are moved forward to open bottom ends of two additional racks 234, to supply patties to the first and second pushers of the loader 222. This dispensing and loading process can be repeated until the hopper 220 is empty. The hopper 220 may include more racks than shown, such that a greater inventory may be held for dispensing to the loader 222 before needing to refill the hopper 220. After moving the slide doors 282A, 282B back to closed positions, the hopper 220 can be reloaded with additional food items. The doors 282A, 282B can be moved manually or can be moved by a door driver including a motor.

It will be appreciated that any of the drivers disclosed above could be manual drivers, such as operated by a manual hand crank, lever, pull, etc., instead of or in addition to a motor. For example, in one embodiment, the loader 22 can be disengaged from the loader driver 44 such that the loader can be moved manually via a handle 22C. For example, if the dispenser 14 is malfunctioning, a user can manually place food items on the bed 42, disengage the loader 22 from the loader driver 44 by manipulating a release, and push the loader toward the oven 12 to push the food into the oven to be cooked.

It will be appreciated that the term “dispensing driver” can refer to a door driver, a carriage driver, and/or a food driver, such as the drivers of that type disclosed above, or another driver associated with the hopper, for dispensing food to the loader. In alternative embodiments, one or more of the dispensing drivers may be omitted.

It will be apparent that modifications and variations are possible without departing from the scope of the invention defined in the appended claims.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A food dispenser for dispensing food to a food cooking device, the food dispenser comprising:
a loader comprising a bed and at least one pusher for pushing food along the bed toward the food cooking device;
a hopper including a plurality of food racks configured to hold a plurality of food items in the hopper for being transferred to the bed of the loader, the food racks being configured to hold the plurality of food items in multiple arrays, one array in front of the other, each array including a plurality of columns; and
a dispensing driver configured to dispense food items from the hopper to the bed of the loader.

2. A food dispenser as set forth in claim 1, wherein the food racks are configured to hold the plurality of food items in the arrays in generally upstanding columns, each column including multiple food items, one food item in the column above another food item in the column.

3. A food dispenser as set forth in claim 1, wherein the dispensing driver includes a motor operable to dispense food items from the hopper to the bed.

4. A food dispenser as set forth in claim 3, further comprising a dispensing driver controller operatively connected to the motor for controlling operation of the motor to dispense food items from the hopper to the bed.

5. A food dispenser as set forth in claim 1, wherein the hopper includes a housing having a door for loading food items into the hopper.

6. A food dispenser as set forth in claim 1, wherein the hopper comprises an insulated housing and a refrigeration system for maintaining food items therein in a refrigerated state.

7. A food dispenser as set forth in claim 1, wherein the hopper includes a housing having an opening out of which food items from the hopper are dispensable to the bed.

8. A food dispenser as set forth in claim 7, further comprising a door configured to selectively open and close the opening.

9. A food dispenser as set forth in claim 8, wherein the dispensing driver comprises a door driver including a motor operatively connected to the door and configured to selectively move the door to open and close the opening.

10. A food dispenser as set forth in claim 7, wherein the opening is shaped as an elongate slot.

11. A food dispenser as set forth in claim 7, further comprising a carriage, the carriage supporting the food racks and being movable relative to the opening for locating one of the food racks in register with the opening for dispensing food items from said one of the food racks to the bed through the opening.

12. A food dispenser as set forth in claim 11, wherein the dispensing driver comprises a carriage driver including a motor operatively connected to the carriage to move the carriage with respect to the opening.

13. A food dispenser as set forth in claim 7, wherein the dispensing driver comprises a food driver configured to push food items from the hopper through the opening.

14. A food dispenser as set forth in claim 13, wherein the dispensing driver comprises a carriage driver configured to move the racks of food relative to the opening to locate one rack of food for having food therefrom pushed by the food driver through the opening.

15. A food dispenser as set forth in claim 1, further comprising a loader driver configured to move the loader between retracted and extended positions for pushing food along the bed toward the cooking device.

16. A food dispenser as set forth in claim 15, wherein the loader driver includes a motor operatively connected to the loader for moving the loader between the retracted and extended positions.

17. A food dispenser as set forth in claim 5, wherein the hopper includes a housing having an opening out of which food items are movable from the hopper to the bed, the opening located to deliver the food items to the bed in a range of movement of the loader between the retracted and extended positions.

18. A food dispenser as set forth in claim 1, wherein the hopper is arranged for gravity feed of food items from the hopper to the bed.

19. A food collector for receiving different types of food items from an outlet of a cooking device, the food collector comprising:
a rack including a plurality of food container supports, each food container support configured to hold a food container for collecting food therein, the plurality of food container supports being arranged in a column, one food support above another food support;
a food container drive operatively connected to the food container supports to move the column of food container supports upward and downward with respect to the outlet of the cooking device to position one of the food container supports for receiving food from the outlet of the cooking device into the food container supported by said one of the food container supports.

20. A food collector as set forth in claim 19, further comprising a food collector controller, the food collector controller operatively connected to the food container drive to operate the food container drive, the food collector controller programmed to operate the food container drive to move the plurality of food container supports to receive food items of different types from the cooking device outlet in different food containers supported by respective different ones of the food container supports.
